(19) United States
(12) Patent Application Publication
(10) Pub. No.: US 2012/0020652 A1
(43) Pub. Date: Jan. 26, 2012

(54) VIDEO RECORDER

(76) Inventor: Seigo Itoh, Osaka (JP)

(21) Appl. No.: 13/145,747

(22) PCT Filed: Jan. 20, 2010
(86) PCT No.: PCT/JP2010/050645

§ 371 Date: Jul. 21, 2011

(30) Foreign Application Priority Data
Jan. 26, 2009 (JP) 2009-014752

(51) Int. Cl. H04N 5/92

(52) U.S. Cl. 386/326; 386/E05.001

(57) ABSTRACT

To provide a video recorder that can receive a plurality of broadcast signals having different channels to perform video recording.

The video recorder is configured to have: a broadcast signal receiving part 11 that receives a plurality of broadcast signals having different channels to create received data; a memory card 16 formed with a file management table 31; a video recording area setting part 41a that writes a predetermined value in a duplicate table 44 of the file management table 31 as status information 53 to thereby allocate a video recording area in the memory card 16; a received data writing part 45 that, while writing storage position information in the duplicate table 44, writes the received data in the video recording area; and a video file registering part 41b that at the end of recording a TV video, writes in the file management table 31 the storage position information in the duplicate table 44, and creates a video file including the received data of a channel having been subjected to the writing.

### TECHNICAL FIELD

The present invention relates to a video recorder, and more particularly, to improvement of a video recorder that receives a broadcast signal to record a TV video.

### BACKGROUND ART

There has been known a cellular phone that can receive a broadcast signal to record a TV video in a removable memory card such as an SD (registered trademark) card. Typically, recording of a TV video is performed by repeating operation that writes received data on a certain sized block basis and updates a FAT in a memory card. The FAT (File Allocation Table) refers to a mapping table that, in order to manage a sequence of pieces of received data constituting one broadcast program as a data file, holds information indicating a storage position of data in the data file.

In general, in the case of receiving a broadcast signal to record a TV video, the same data cannot be acquired again, and therefore received data should be written in real time. Also, if there are a plurality of tuners respectively for receiving broadcast signals, a plurality of broadcast signals having different channels can be simultaneously received; however, in order to write pieces of received data of the respective channels in the same memory card in real time, depending on the number of channels that are simultaneously received, an access speed should be increased. However, in the case of writing in the same memory card, data blocks of a plurality of channels, each of which includes pieces of received data, cannot be simultaneously written, and therefore the data blocks should be written with switching a channel to be written. For this reason, a conventional video recorder has a problem that, every time a channel to be written is switched, an FAT should be updated, and therefore even in the case of increasing an access speed, an overhead associated with the FAT update is large and recording cannot be performed in time.

In addition, Patent literature 1 describes a video recording device that writes pieces of received data corresponding to a plurality of broadcast signals having different channels in parallel. The video recording device described in Patent literature 1 is one that creates a virtual file for each of the broadcast signals having different channels to write received data, but not one that reduces the overhead associated with the FAT update. Also, Patent literature 2 discloses a technique that continuously records two broadcast programs having different channels. A recorder described in Patent literature 2 is one that process two pieces of broadcast program data having different channels as one stream, but not one that reduces the overhead at the time of simultaneously receiving a plurality of broadcast signals having different channels to record videos.

### CONVENTIONAL TECHNIQUE LITERATURE

### Patent Literature

Patent literature 1: Japanese published unexamined patent application No. 2006-4572

Patent literature 2: Japanese published unexamined patent application No. 2006-19888

### SUMMARY OF THE INVENTION

### Problem to be Solved by the Invention

The present invention is made in consideration of the above-described situations, and has an object to provide a video recorder that can receive a plurality of broadcast signals having different channels to record videos. More particularly, the present invention has an object to provide a video recorder that can, without making an access speed larger than necessary, write pieces of received data corresponding to a plurality of channels in real time. Also, the present invention has an object to provide a video recorder that can record a plurality of TV videos on air in one memory card.

### Means Adapted to Solve Problems

A video recorder according to a first aspect of the present invention is a video recorder that receives a broadcast signal to record a TV video, the video recorder including: broadcast signal receiving means adapted to receive two or more broadcast signals having different channels to create received data; a nonvolatile memory element that holds the TV video including the received data as a data file, and is formed with a file management table that holds storage position information on the data in the data file; a volatile memory that holds a duplicate table of the file management table; video recording area setting means adapted to write a predetermined value in the duplicate table as status information to thereby allocate in the memory element a video recording area for recording the TV video; received data writing means adapted to, while writing the storage position information in the duplicate table, write the received data in the video recording area; and video file registering means adapted to, at an end of recording the TV video, write in the file management table the storage position information in the duplicate table, and create a video file including the received data of the channel having been subjected to the writing.

According to such a configuration, the video recording area for recording the TV video is preliminarily allocated in the memory element to write the received data, and at the end of recording the TV video, the video file including the received data of the channel having been subjected to the writing is created, so that an overhead associated with update of the file management table can be reduced. Accordingly, a video recorder that can, without making an access speed larger than necessary, write pieces of received data corresponding to a plurality of channels in real time can be realized.

A video recorder according to a second aspect of the present invention is configured such that, in addition to the above configuration, the video file registering means creates, at the end of recording the TV video of one channel, the video file including received data of the channel having been subjected to the recording. According to such a configuration, at the end of recording the TV video of the one channel, the video file is created, and therefore even if during video recording of another channel, writing of received data is interrupted due to the influence of power off or the like, the TV video having been recorded can be held as a data file as in the conventional case and read from the memory element.

A video recorder according to a third aspect of the present invention is configured such that, in addition to the above configuration, the video file registering means creates, at the end of recording the TV videos of all receivable channels, the video file for each of the channels. According to such a configuration, at the end of recording the TV videos of the all receivable channels, video files are created, and therefore a processing load during the recording of the TV videos can be suppressed from being increased.

A video recorder according to a fourth aspect of the present invention is configured such that, in addition to the above configuration, the memory element is a removable memory card. According to such a configuration, the overhead associated with the update of the file management table in the memory card is reduced, and therefore a plurality of videos on air can be recorded in the one memory card. Further, at the end of video recording, storage position information is written in the file management table to create a video file, and therefore even if video recording is interrupted due to power off or the like, meaningless position information can be prevented from being left in the file management table in the memory card. Accordingly, at the time of accessing the memory card in another device, written received data associated with interrupted video recording are handled as being absent, and therefore the received data can be prevented from being erroneously recognized.

### Effect of the Invention

According to the video recorder according to the present invention, the video recording area for recording a TV video is preliminarily allocated in the memory element to write received data, and at the end of recording the TV video, a video file including the received data of a channel having been subjected to the writing is created, so that the overhead associated with the update of the file management table can be reduced. Accordingly, without making an access speed larger than necessary, pieces of received data corresponding to a plurality of channels can be written in real time, and a plurality of broadcast signals having different channels can be received and recorded.

### BRIEF DESCRIPTION OF THE DRAWINGS

FIG. 1 is a block diagram illustrating an example of a schematic configuration of a video recorder according to an embodiment of the present invention.

FIG. 2 is an explanatory diagram schematically illustrating an operation example of the video recorder 1 of FIG. 1, in which an example of a directory structure created by a file management system using a FAT is illustrated.

FIG. 3 is an explanatory diagram schematically illustrating the operation example of the video recorder 1 of FIG. 1, in which an example of a file management structure formed in a memory card 16 is illustrated.

FIG. 4 is a block diagram illustrating a configuration example in a main part of the video recorder 1 of FIG. 1, in which an example of a functional configuration inside an access control part 15 is illustrated.

FIG. 5 is an explanatory diagram schematically illustrating an operation example at the time of video recording in the video recorder 1 of FIG. 1, and illustrates the case where broadcast programs of channels A and B are simultaneously recorded.

FIG. 6 is an explanatory diagram schematically illustrating the operation example at the time of video recording in the video recorder 1 of FIG. 1, and illustrates situations inside the memory card 16 at the end of the video recording.

FIG. 7 is an explanatory diagram schematically illustrating the operation example at the time of video recording in the video recorder 1 of FIG. 1, and illustrates situations inside a file management table 31 in the memory card 16 of FIG. 6.

FIG. 8 is a flowchart illustrating an example of operation at the time of video recording in the video recorder 1 of FIG. 1.

### BEST MODE FOR CARRYING OUT THE INVENTION

### <Video Recorder>

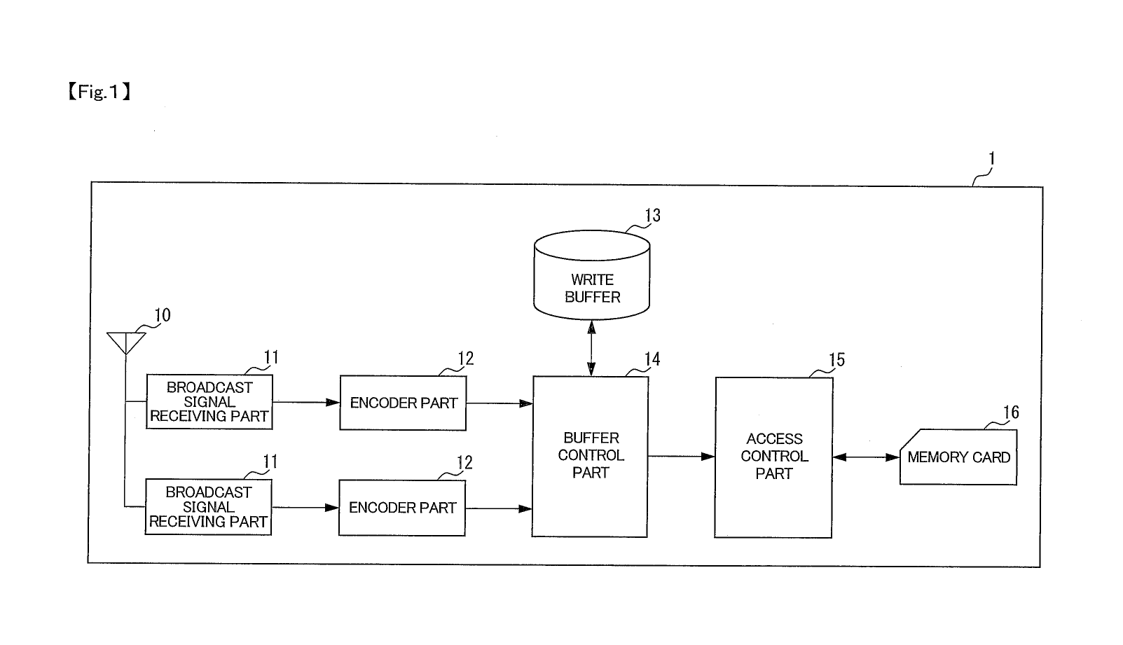

FIG. 1 is a block diagram illustrating an example of a schematic configuration of a video recorder 1 according to an embodiment of the present invention. The video recorder 1 is an electronic device that receives a broadcast signal to record a TV video in a removable memory card 16 such as an SD card, and for example, one that is incorporated in a mobile information terminal having a display and operation keys as one function is envisaged.

The video recorder 1 is configured to have an antenna 10, two broadcast signal receiving parts 11, two encoder parts 12, a write buffer 13, a buffer control part 14, an access control part 15, and a memory card 16. The antenna 10 is one that is intended to receive a broadcast wave transmitted from a broadcast station, and a received broadcast signal is supplied to each of the broadcast signal receiving parts 11.

Each of the broadcast signal receiving parts 11 is a tuner that extracts a signal of a preliminarily specified channel, and performs operation that receives a broadcast signal to generate received data, and outputs it to corresponding one of the encoder parts 12. For example, in the case of terrestrial digital broadcasting that uses a specific frequency band to provide a TV video or the like, operation that extracts a frequency component corresponding to a channel is performed.

The two broadcast signal receiving parts 11 can specify independent channels, and respectively extract different channels.

Each of the encoder parts 12 is data format converting means adapted to perform conversion into a predetermined saving format for writing received data of a broadcast signal in the memory card 16, and the received data having been subjected to the data format conversion is outputted to the buffer control part 14. Specifically, processing to encrypt received data, processing to change bit rates of moving images and sound, processing to change an image size of moving images, processing to change a data compression format are performed. Each of the encoder parts 12 can individually process received data from corresponding one of the broadcast signal receiving parts 11.

The write buffer 13 is an RAM (Random Access Memory) that temporarily stores received data. The buffer control part 14 performs operation that, in order to write received data from the encoder part 12 in the memory card 16 on a certain-sized block basis, uses the write buffer 13 to perform buffering. For example, with use of 512-byte data as one block, buffering of received data is performed.

Also, in the case of simultaneously inputting pieces of received data respectively corresponding to two broadcast signals having different channels from the encoder parts 12, the buffering is performed such that the pieces of received data of the respective channels are alternately outputted to the access control part 15 on the certain-sized block basis.

The memory card 16 is a removable storage medium, and configured to have: for example, a nonvolatile semiconductor memory element such as a flash memory; a controller that controls data reading/writing from/to the semiconductor memory element; and a cache memory that temporarily stores data at the time of reading/writing.

The access control part 15 is file management means adapted to read/write received data from/to the memory card 16, and a sequence of pieces of written received data are held as a data file. In the memory card 16, such a data file, and a file folder including a plurality of data files are held.

Reading/writing of received data from/to the memory card 16 is performed by referring to a file management table in the memory card 16. In the file management table, storage position information indicating a storage position of data within a data file is held.

In this embodiment, an example of the case of using the FAT to read/write received data is described below. In a file management system using the FAT as the file management table, file folders and data files are managed on the basis of a directory structure that uses a highest hierarchy level as a root directory, and lower level directories belonging to the root directory as subdirectories.

### <Directory Structure>

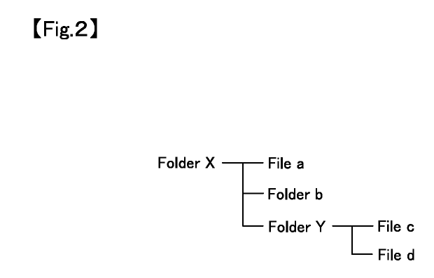

FIG. 2 is an explanatory diagram schematically illustrating an operation example of the video recorder 1 of FIG. 1, in which an example of a directory structure created by the file management system using the FAT is illustrated. In the file management system using the FAT, file folders, or directories including data files are formed in a tree-like shape.

In this example, a file folder “Folder X” is set as an upper level directory, and as three subdirectories belonging to the directory, two data files “File a” and “File b” and one file folder “Folder Y” are formed. Also, in the file folder “Folder Y”, two data files “File c” and “File d” are formed as lower level subdirectories.

Such a directory structure is identified by creating directory information including identification information such as a folder name or a file name.

For example, in an SD video format, below a root directory “SD-VIDEO”, a file folder “PRG0xx” is created as a subdirectory. In the one file folder “PRG0xx”, a video file for storing one broadcast program, and a control file for storing control data are created.

In the video file, video data and sound data are stored, and in the control file, saved date and time, title, reproduction time, creator's name, and the like of the video file are stored.

In the present embodiment, at the end of recording a TV video, a file folder and a data file for video recording data are created, and a file name is provided in order of completion of video recording, such as “PRG001” or “PRG002”

### <File Management Structure>

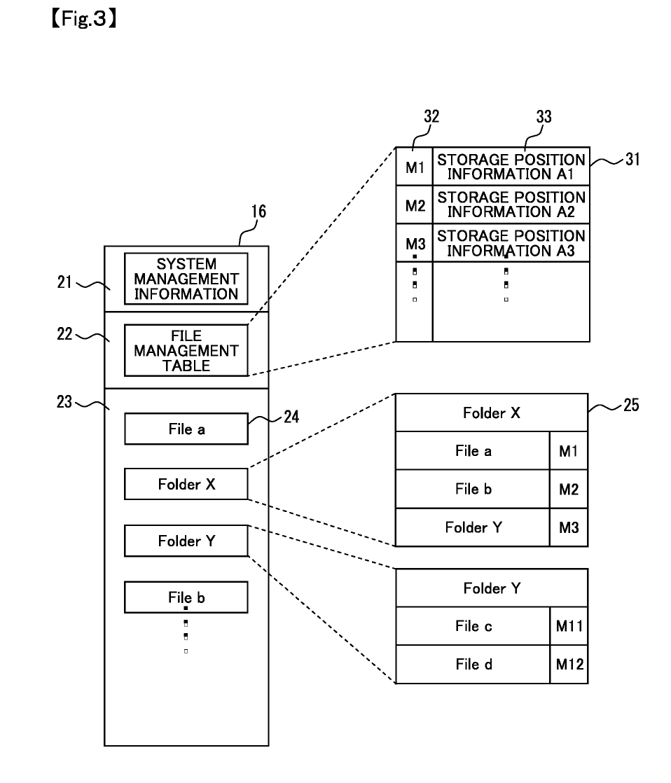

FIG. 3 is an explanatory diagram schematically illustrating the operation example of the video recorder 1 of FIG. 1, in which an example of a file management structure formed in the memory card 16 is illustrated. In the case of the file management system using the FAT, in the memory card 16, a storage area 21 for system management information, storage area 22 for the file management table 31, and data area 23 are formed.

As the system management information in the storage area 21, a file system and specific information on the memory card 16 are held. For example, a boot program, parameter of the FAT, list information on directories belonging to the root directory, and the like are held. As the parameter of the FAT, for example, when data is written to the memory card 16 on a cluster basis, the number of sectors constituting the one cluster is held.

In the file management table 31, pieces of storage position information 33 on data in a data file 24 and subdirectory 25 are held with being related to pointers 32. The pointers 32 are pieces of position information for relating file folders and data files in the root directory and subdirectories and corresponding file management tables 31 to each other.

In this example, as the file management table 31, “Storage position information A1” is held with being related to a pointer “M1” for the data file “File a”; “Storage position information A2” is held with being related to a pointer “M2” for the data file “File b”; and “Storage position information A3” is held with being related to a pointer “M3” for the file folder “Folder Y”.

A storage position of data in the data file 24, or a storage position of the subdirectory 25 is identified by referring to the file management table 31.

The data area 23 is a storage area in which the data file 24 and content of the subdirectory 25 are stored, and sectioned into a number of sectors.

In the file management system based on the FAT, the data area 23 is sectioned into the sectors each having an area of 512 bytes, and data is read/written on a sector basis. In this embodiment, it is assumed that a continuous area including a predetermined number of sectors is referred to as a cluster, and at the time of writing data, the writing is performed on the cluster basis.

In an actual FAT file system, a file management table is present for each cluster, and a relative position from a top of the file management table directly represents a position (physical position) of a cluster in the memory card 16. Accordingly, the pointers 32 held in the subdirectory 25 correspond to pieces of position information indicating relative positions from a top of the file management table.

Also, as storage position information 33 in the file management table, in the case of FAT 16, if a corresponding cluster is in use, 0xffff to 0xffff, or link destination information for the case where data is stored astraddle a plurality of clusters is written. On the other hand, if the corresponding cluster is not in use, 0x0000 is written.

In the case of simultaneously receiving two broadcast signals having different channels to write pieces of received data in the same memory card 16, in the conventional video recorder, operation that writes one block of pieces of received data corresponding to one of the channels to update the file management table 31, and switches a write object to the other channel should be repeated, and therefore an overhead is large. Specifically, first, operation that refers to the file management table 31 to search a writable area, and while writing storage position information 33 in the file management table 31, writes the one block of pieces of received data corresponding to the one channel is performed.

Then, once the one block of pieces of received data corresponding to the one channel is written, the write object is switched to the other channel, and the operation that refers to the file management table 31 to again search a writable area is repeated.

On the other hand, in the present embodiment, operation that writes a predetermined value as status information in a duplicate table obtained by duplicating the file management table 31 to thereby preliminarily allocate a video recording area for recording a TV video in the memory card 16, and while writing storage position information in the duplicate table, alternately writes the pieces of received data of the respective channels in the video recording area is performed.

### <Access Control Part>

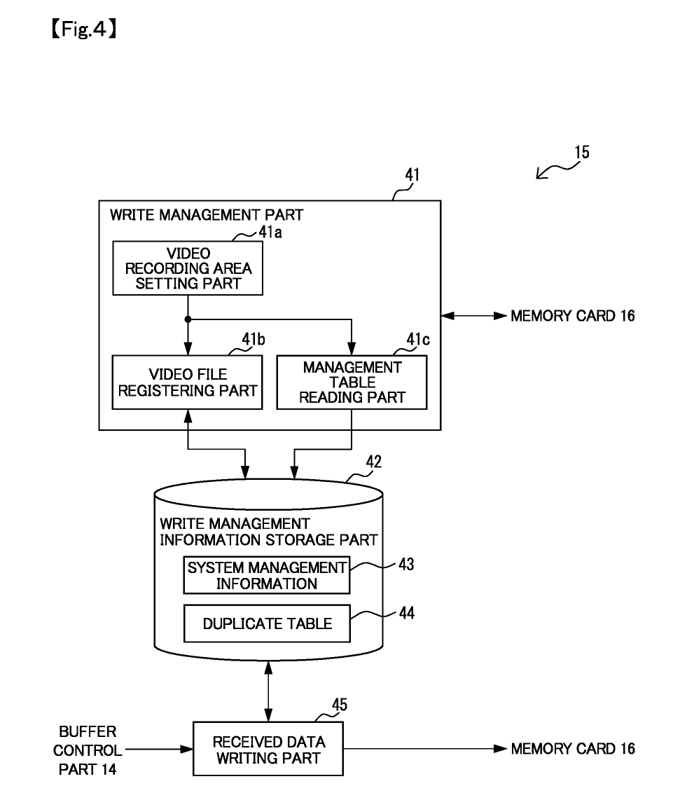

FIG. 4 is a block diagram illustrating a configuration example in a main part of the video recorder 1 of FIG. 1, in which an example of a functional configuration inside the access control part 15 is illustrated. The access control part 15 is configured to have a write management part 41, a write management information storage part 42, and a received data writing part 45, and performs operation that writes received data from the buffer control part 14 to the memory card 16.

The write management part 41 includes a video recording area setting part 41a, a video file registering part 41b, and a management table reading part 41c, and at the start of video recording, performs operation that refers to the file management table 31 in the memory cart 16 to search a writable area, and allocates a video recording area for recording a TV video. Then, at the end of recording the TV video, operation that creates a video file including pieces of received data of a channel having been subjected to the writing, and a file folder is performed.

The video recording area setting part 41a performs the operation that writes the predetermined value as the status information in a duplicate table 44 of the file management table 31 to thereby allocate the video recording area for recording a TV video in the memory card 16. Specifically, operation that, regarding a predetermined cluster, assigns a status to “assigned to the other” to thereby allocate the video recording area is performed.

The video recording area that is, at the start of recording a TV video, allocated by the video recording area setting part 41a has, in the case of programmed video recording of which video recording starting time and video recording ending time are preliminarily specified, a size enough to write moving images corresponding to a period of time from the starting time to the ending time. Also, in the case of start video recording at user operation timing, a data area having a certain size sufficiently larger than the received data writing unit, for example, one cluster is allocated.

The management table reading part 41c performs operation that, on the basis of an instruction from the video recording area setting part 41a, reads the file management table 31 and system management information from the memory cart 16 to updates system management information 43 and the duplicate table 44 in the write management information storage part 42.

The write management information storage part 42 is an RAM that holds the system management information 43 and the duplicate table 44 as pieces of write management information.

The video file registering part 41b performs operation that, at the end of recording a TV video, writes storage position information inside the duplicate table 44 in the file management table 31, and creates a video file including pieces of received data corresponding to a channel having been subjected to the writing.

The received data writing part 45 performs operation that, while writing storage position information in the duplicate table 44 in the write management information storage part 42, writes received data from the buffer control part 14 in the video recording area allocated in the memory card 16.

In the video file registering part 41b, it is assumed that, at the end of recording a TV video of one of the channels, a video file including pieces of received data of the channel having been subjected to the video recording is created.

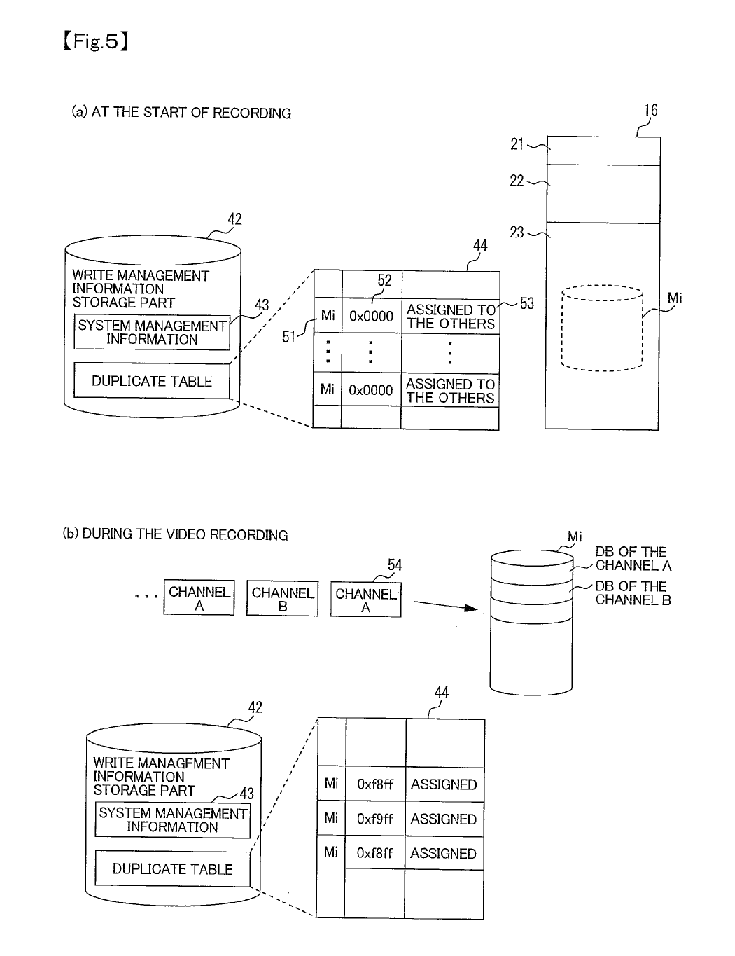

FIGS. 5 (a) and (b) are explanatory diagrams schematically illustrating an operation example at the time of video recording in the video recorder 1 of FIG. 1, and illustrate the case where broadcast programs of channels A and B are simultaneously recorded. FIG. 5 (a) illustrates situations inside the write management information storage part 42 and the memory card 16 at the start of the video recording. Also, FIG. 5 (b) illustrates situations where in a video recording area Mi allocated in the data area 23 of the memory card 16, DBs (data blocks) 54 each including pieces of received data are written.

In the duplicate table 44 inside the write management information storage part 42, pieces of storage position information 52 and pieces of status information 53 are held with being related to pointers 51.

At the start of recording a broadcast program, by writing in the duplicate table 44 a predetermined value, for example, “assigned to the other”, as the status information 53, the video recording area Mi for recording a TV video is allocated in the data area 23 of the memory card 16.

By writing the status information “assigned to the other” in the duplicate table 44, writing other data in the video recording area Mi or deleting received data in the video recording area Mi can be prohibited during the video recording. In the video recording area Mi, for example, a pointer “Mi” is automatically assigned.

During the video recording, pieces of received data that are inputted from the buffer control part 14 on the block basis are sequentially written in the video recording area Mi of the memory card 16. In this example, a DB 54 including pieces of received data corresponding to the broadcast program of the channel A and a DB 54 including pieces of received data corresponding to the broadcast program of the channel B are, for example, alternately inputted from the buffer control part 14 to the received data writing part 45 of the access control part 15, and written in the video recording area Mi by the received data writing part 45.

A DB 54 to be written includes certain-sized, for example, one cluster of pieces of received data. Also, during the video recording, every time a DB 54 is written in the video recording area Mi, corresponding storage position information is written in the duplicate table 44.

This example illustrates the case where the channels A and B are broadcasted at the same bit rate. Specifically, along with writing of the DB 54 of the channel A, as corresponding storage position information 52, “0xf8ff” is written, and the status information 53 is rewritten from “assigned to the other” to “assigned”. Then, along with writing of the DB54 of the channel B, as corresponding storage position information 52, “0xf9ff” is written, and the status information 53 is written from “assigned to the other” to “assigned”. Subsequently, when the DB54 of the channel A is written in the video recording area Mi, as corresponding storage position information 52, “0xf8ff” is written in the next cluster.

If the channels A and B are broadcasted at not the same bit rate but, for example, the channel B is broadcasted at a bit rate twice as much as that of the channel A, DBs 54 are written in the order of A, B, B, A, B, B, A, . . . .

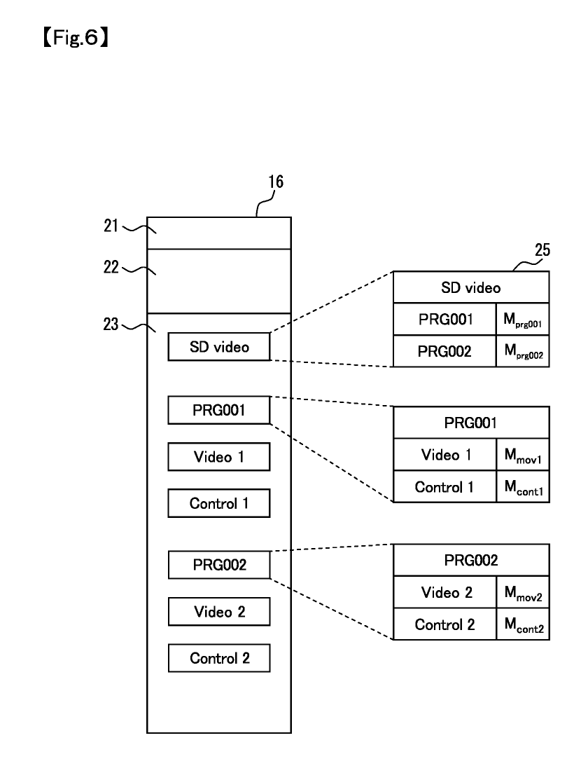

FIG. 6 is an explanatory diagram schematically illustrating the operation example at the time of video recording in the video recorder 1 of FIG. 1, and illustrates situations inside the memory card 16 at the end of video recording. At the end of recording a broadcast program, a video file including pieces of received data corresponding to a channel having been subjected to the writing, and a file folder for video recording data are created in the memory card 16 by the video file registering part 41b.

Specifically, in the data area 23, as subdirectories 25, “SD video”, “PRG001”, and “PRG002” are created, and as data files 24, “Video 1”, “Control 1”, “Video 2”, and “Control 2” are created.

The file folder “SD video” is a root directory including the file folders “PRG001” and “PRG002”, and a file name table that holds the folder names with relating them to pointers 32 is stored in the data area 23.

In this example, the folder name “PRG001” is held with being related to a pointer “M_{prg001}”, corresponding to the broadcast program of the channel A, and the folder name “PRG002” is held with being related to a pointer “M_{prg002}”, corresponding to the broadcast program of the channel B.

The file folder “PRG001” is a subdirectory including the data files “Video 1” and “Control 1”, and a file name table that holds the file names with relating them to pointers 32 is stored in the data area 23.

In this example, the file name “Video 1” is held with being related to a pointer “Mₘₒᵥ₁”, and the file name “Control 1” is held with being related to a pointer “M_{cont1}”.

In the data file “Video 1”, the pieces of received data of the channel A are stored, and in the data file “Control 1”, control data is stored.

Also, the file folder “PRG002” is a subdirectory including the data files “Video 2” and “Control 2”, and a file name table that holds the file names with relating them to pointers 32 is stored in the data area 23.

In this example, the file name “Video 2” is held with being related to a pointer “Mₘₒᵥ₂”, and the file name “Control 2” is held with being related to a pointer “M_{cont2}”.

In the data file “Video 2”, the pieces of received data of the channel B are stored, and in the data file “Control 2”, control data is stored.

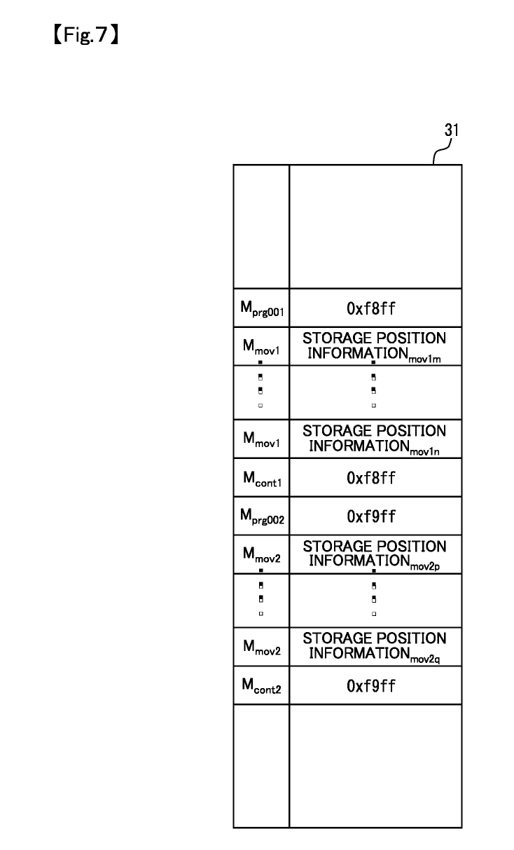

FIG. 7 is an explanatory diagram schematically illustrating the operation example at the time of video recording in the video recorder 1 of FIG. 1, and illustrates situations inside the file management table 31 in the memory card 16 of FIG. 6. At the end of recording a broadcast program, based on the duplicate table 44 in the write management information storage part 42, pieces of storage position information are written in the file management table 31 by the video file registering part 41b.

In this example, the storage position information “0xf8ff” is held with being related to the pointer “M_{prg001}” for the file folder “PRG001”, and in respective clusters that store pieces of data in the data file “Video 1”, “Storage position information mov1m” to “Storage position information mov1n” are held with being related to the pointer “Mₘₒᵥ₁”. Also, the storage position information “0xf8ff” is held with being related to the pointer “M_{cont1}” for the data file “Control 1”.

The storage position information “0xf9ff” is held with being related to the pointer “M_{prg002}” for the file folder “PRG002”, and in respective clusters that store pieces of data in the data file “Video 2”, “Storage position information mov2p” to “Storage position information mov2q” are held with being related to the pointer “Mₘₒᵥ₂”. Also, the storage position information “0xf9ff” is held with being related to the pointer “Mₒₒₙₜ₂” for the data file “Control 2”.

At the end of video recording, by rewriting the storage position information 33 in the file management table 31 from “0x0000” to “0xf8ff” or “0xf9ff”, a status of a corresponding cluster is changed from an unused state to a use state.

As described, by writing the pieces of storage position information 33 in the file management table 31 to create the video files and file folders, at the end of video recording, the pieces of received data corresponding to the broadcast program of the channel A, and the pieces of received data corresponding to the broadcast program of the channel B can be read/written as pieces of independent video recording data.

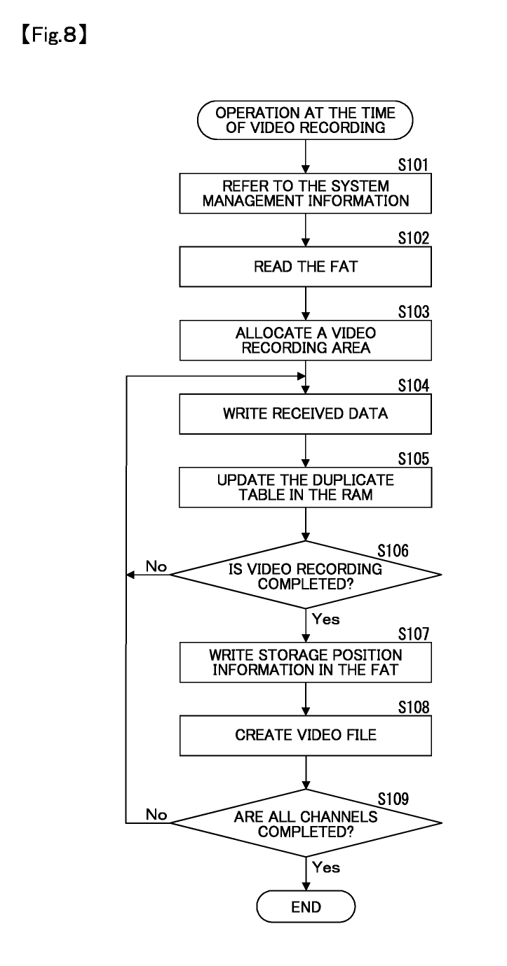

Steps S101 to S109 in FIG. 8 represent a flowchart illustrating an example of operation at the time of video recording in the video recorder 1 of FIG. 1. First, the video recording area setting part 41a refers to the system management information and the file management table 31 in the memory card 16 to search a received data writable area, and reads the file management table 31 in the RAM (write management information storage part 42) (Steps S101 and S102). Then, by writing a predetermined value in the duplicate table 44 as the status information 53, a video recording area for a TV video is allocated in the memory card 16 (Step S103).

Subsequently, the received data writing part 45 repeats, on the cluster basis, writing pieces of received data from the buffer control part 14 in the video recording area allocated in the memory card 16 to update the duplicate table 44 in the RAM (Steps S104 to S106).

When recording of a TV video of one channel is completed, at the end of the video recording, the video file registering part 41b writes pieces of storage position information in the file management table 31 in the memory card 16 to create file folders and data files for video recording data (Steps S106 to S108).

A processing procedure from Steps S104 to S108 is repeated until recording of TV videos of all receivable channels is completed (Step S109).

According to the present embodiment, the video recording area for recording a TV video is preliminarily allocated in the memory card 16 to write pieces of received data, and at the end of recording the TV video, a video file including the pieces of received data corresponding to a channel having been subjected to the writing is created, so that the overhead associated with the FAT update can be reduced. Accordingly, without making an access speed to the memory card 16 larger than necessary, pieces of received data corresponding to a plurality of channels can be written in real time.

Also, at the end of recording a TV video of one channel, video files and file folders are created, and therefore even if during video recording of another broadcast signal, the video recording is interrupted due to the influence of power off, removal of the memory card 16 from the recorder main body, or the like, the TV video having been recorded can be held as a data file as in the conventional case, and read from the memory card 16.

Further, at the end of video recording, pieces of storage position information 33 are written in the file management table 31 to create a video file, and therefore even if video recording is interrupted due to power off or the like, meaningless position information can be prevented from being left in the file management table 31 in the memory card 16. That is, during a period before the end of video recording, pieces of storage position information are held in the RAM (write management information storage part 42) on the main body side, and the FAT on the memory card 16 side remains in an unused state, so that even if during video recording, power is shut off, meaningless information can be prevented from being held in the file management table 31. Accordingly, at the time of accessing the memory card 16 in another device, written received data associated with interrupted video recording is handled as being absent, and therefore the received data can be prevented from being erroneously recognized.

Note that, in the present embodiment, an example of the case where at the end of recording a TV video of one channel, file folders and data files for video recording data are created in the memory card 16 is described; however, the present invention is not limited to this. For example, at the end of recording TV videos of all receivable channel, video files and file folders may be created for each of the channels.

If a configuration is made in this manner, at the end of recording the TV videos of the all receivable channel, the file folders and data files for video recording data are created in the memory card 16, and therefore a processing load during the recording of the TV videos can be suppressed from being increased. Accordingly, even in the case of, simultaneously with the end of recording one broadcast program, starting to record a broadcast program of another channel, these broadcast programs can be normally recorded.

Also, in the present embodiment, an example of the case where, as a nonvolatile memory element for storing received data of a broadcast signal, the removable memory card 16 is used is described; however, the present invention is not limited to this, but may use a memory element that cannot be removed from the recorder main body. For example, a configuration that uses a semiconductor memory element such as an SSD (Solid State Disk), or a magnetic memory element such as an HDD (Hard Disk Drive) to store received data is also included in the present invention.

This application claims priority under the Paris Convention based on the following patent application in Japan: the patent application filed on Jan. 26, 2009 (Japanese patent application No. 2009-014752), the entire content of which is incorporated herein by reference.

### DESCRIPTION OF REFERENCE NUMERALS

1 Video recorder
10 Antenna
11 Broadcast signal receiving part
12 Encoder part
13 Write buffer
14 Buffer control part
15 Access control part
16 Memory card
23 Data area
24 Data file
25 Subdirectory
31 File management table
32 Pointer
33 Storage position information
41 Write management part
41a Video recording area setting part
41b Video file registering part
41c Management table reading part
42 Write management information storage part
43 System management information
44 Duplicate table
45 Received data writing part
51 Pointer
52 Storage position information
53 Status information

1. A video recorder that receives a broadcast signal to record a TV video, the video recorder comprising:
broadcast signal receiving means adapted to receive two or more broadcast signals having different channels to create received data;
a nonvolatile memory element that holds the TV video including the received data as a data file, and is formed with a file management table that holds storage position information on the data in the data file;
a volatile memory that holds a duplicate table of the file management table;
video recording area setting means adapted to write a predetermined value in the duplicate table as status information to thereby allocate in the memory element a video recording area for recording the TV video;
received data writing means adapted to, while writing the storage position information in the duplicate table, write the received data in the video recording area; and
video file registering means adapted to, at an end of recording the TV video, write in the file management table the storage position information in the duplicate table, and create a video file including the received data of the channel having been subjected to the writing.

2. The video recorder according to claim 1, wherein
the video file registering means creates, at the end of recording the TV video of one channel, the video file including received data of the channel having been subjected to the recording.

3. The video recorder according to claim 1, wherein
the video file registering means creates, at the end of recording the TV videos of all receivable channels, the video file for each of the channels.

4. The video recorder according to claim 1, wherein
the memory element is a removable memory card.
